(19) United States
(12) Patent Application Publication
(10) Pub. No.: US 2025/0148325 A1
(43) Pub. Date: May 8, 2025

(54) CALCULATION MODEL, INFORMATION PROCESSING METHOD, STORAGE MEDIUM, AND INFORMATION PROCESSING DEVICE

(71) Applicant: TDK CORPORATION, Tokyo (JP)

(72) Inventors: Tsuyoshi SUZUKI, Tokyo (JP); Kaito ASAI, Tokyo (JP)

(73) Assignee: TDK CORPORATION, Tokyo (JP)

(21) Appl. No.: 18/292,120

(22) PCT Filed: Jul. 27, 2021
(86) PCT No.: PCT/JP2021/027646

§ 371 Date: Aug. 2, 2024

(51) Int. Cl. G06N 7/01

(52) U.S. Cl. CPC G06N 7/01

(57) ABSTRACT

This calculation model is a calculation model that is applicable to an Ising model or a QUBO, and includes a plurality of Ising bits and a first auxiliary bit, in which each of the plurality of Ising bits and the first auxiliary bit is a binary variable, and the plurality of Ising bits represents each of the options in combinatorial optimization problems as a combination of the variables, and the first auxiliary bit indicates a value obtained by performing logical calculation on two or more values among a plurality of values indicating the options.

### TECHNICAL FIELD

The present invention relates to a calculation model, an information processing method, a calculation program, and an information processing device.

### BACKGROUND ART

There have been attempts to obtain an optimal solution to a combinatorial optimization problem using quantum annealing (for example, Non-Patent Document 1).

### CITATION LIST

### Non Patent Literature

[Non Patent Literature 1]

Hiroto Teranishi, Shota Nagayama, “Excited state utilization of quantum annealing in simple graph minimum cut problem,” Institute of Electronics, Information and Communication Engineers, Type 2 Research Material, Quantum Information Technology Study Group, QIT2019-89 (2019.11)

### SUMMARY OF INVENTION

### Technical Problem

In quantum annealing machines, errors may occur due to unintended quantum transitions, noise, and the like, and an optimal solution may not be obtained appropriately.

The present invention has been made in view of the circumstances described above, and an object thereof is to provide a calculation model, an information processing method, a calculation program, and an information processing device that are not likely to be affected by errors caused by noise or the like.

### Solution to Problem

The present invention provides the following means to solve the problems described above.
(1) A calculation model according to a first aspect is a calculation model that is applicable to an Ising model or a QUBO. This calculation model includes a plurality of Ising bits and a first auxiliary bit. Each of the plurality of Ising bits and the first auxiliary bit is a binary variable. The plurality of Ising bits represent each of the options in combinatorial optimization problems as a combination of the variables. The first auxiliary bit indicates a value obtained by performing logical calculation on two or more values among a plurality of values indicating the options.
(2) In the calculation model described above, the logical calculation may be an exclusive OR.
(3) In the calculation model described above, the logical calculation may be a logical disjunction.
(4) In the calculation model described above, the logical calculation may be a logical conjunction.
(5) The calculation model described above may further include a second auxiliary bit. The second auxiliary bit indicates a value obtained by performing a logical disjunction of two or more values among a plurality of values indicating the options.
(6) In the calculation model described above, the plurality of Ising bits may perform binary representation on the options.
(7) In the calculation model described above, the auxiliary variable may further include a third auxiliary bit. The third auxiliary bit indicates a value obtained by performing a logical calculation on a value of the first auxiliary bit and a value that is not used in the logical calculation to obtain the first auxiliary bit among a plurality of values indicating the options.
(8) In the calculation model described above, the Ising model or the QUBO may be executed by quantum annealing machines.
(9) An information processing method according to a second aspect is an information processing method using the calculation model described above. This information processing method includes a comparison process of comparing a value of the first auxiliary bit with a result of performing the same logical calculation as when a value of the first auxiliary bit is obtained for an Ising bit corresponding to a value used in the logical calculation of the first auxiliary bit.
(10) The information processing method according to the aspect described above may further include an extraction process of enumerating combinations of the variables that are selectable by the plurality of Ising bits from the value of the first auxiliary bit when comparison results in the comparison process do not match, a calculation process of performing a calculation using the calculation model for each of the listed combinations, and a replacement process of replacing a combination of variables of the plurality of Ising bits when an error is detected with a combination of variables that minimizes a result of calculation among the combinations of the variables that are selectable by the plurality of Ising bits.
(11) In the extraction process of the information processing method according to the aspect described above, a combination having a small Hamming distance with the plurality of Ising bits may be extracted from among the combinations of the variables that are selectable by the plurality of Ising bits.
(12) A calculation program according to a third aspect includes a calculation program that performs a calculation using the calculation model according to the aspect described, and a comparison program. The comparison program compares the value of the first auxiliary bit with a result of performing the same logical calculation as when a value of the first auxiliary bit is obtained for an Ising bit corresponding to the value used in the logical calculation of the first auxiliary bit.
(13) The calculation program according to the aspect described above may further include an extraction program and a correction program. An extraction program lists combinations of the variables that are selectable by the mismatched options on the basis of the value of the first auxiliary bit when the comparison results using the comparison program do not match. A correction program replaces variables when the comparison results do not match with the combination of variables that minimizes a result of calculation using the calculation program among the combinations of the variables that are selectable by the options.
(14) An information processing device according to a fourth aspect includes the calculation program according to the aspect described above.

### Advantageous Effects of Invention

The calculation model, the information processing method, the calculation program, and the information processing device according to the present invention are not likely to be affected by errors caused by noise or the like.

### BRIEF DESCRIPTION OF DRAWINGS

FIG. 1 is an image diagram of an Ising model and a QUBO.

FIG. 2 is an image diagram of a calculation model according to the present embodiment.

FIG. 3 is an example of a case in which options are displayed in a one-hot representation.

FIG. 4 is an example of a case in which options are displayed in a binary representation.

FIG. 5 is a specific example of the calculation model according to the present embodiment.

FIG. 6 is a flow diagram of an information processing method according to the present embodiment.

FIG. 7 is another example of the calculation model according to the present embodiment.

FIG. 8 is another example of the calculation model according to the present embodiment.

FIG. 9 is another example of the calculation model according to the present embodiment.

FIG. 10 is another example of the calculation model according to the present embodiment.

### DESCRIPTION OF EMBODIMENTS

Hereinafter, the present embodiment will be described in detail with reference to the drawings as appropriate. In the drawings used in the following description, characteristic parts of the present embodiment may be shown enlarged for convenience in order to make them easier to understand, and dimensional ratios of the components may differ from the actual ones. The materials, dimensions, and the like exemplified in the following description are merely examples, and the present invention is not limited thereto, and can be implemented with appropriate changes within a range not changing the gist of the invention.

### First Embodiment

A calculation model according to the first embodiment is a calculation model applicable to an Ising model or QUBO used for quantum annealing. Quantum annealing is an algorithm that obtains a state with a minimum energy (a ground state) according to the calculation model.

An Ising model is a model that predicts a stable state as a whole when a plurality of elements interact and a forcing force is applied to each element.

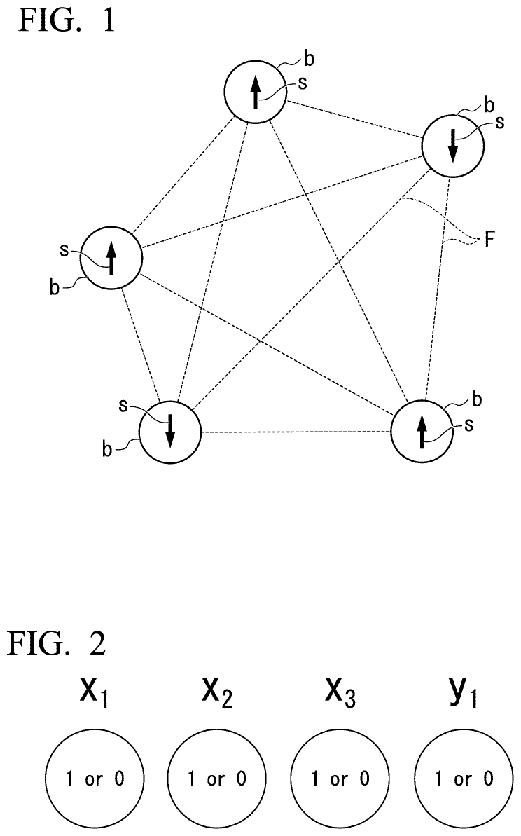

FIG. 1 is an image diagram of the Ising model. The Ising model has a plurality of bits b that interact with each other under a forcing force F. Each bit b consists of a spin s. A spin s indicates either an upward or downward state. Each bit b is represented by a variable indicating a binary state. Depending on setting of the forcing force F, a state in which adjacent spins s are in equilibrium becomes a stable state, or a state in which they are antiparallel becomes a stable state. The forcing force F is referred to as an interaction parameter.

The Ising model is represented by the following energy function (cost function).

$$H = {\sum }_{i \neq j} {J}_{ij} {σ}_{i} {σ}_{j} + {\sum }_{i} {h}_{i} {σ}_{i} \qquad [ Equation 1 ]$$

Here, σᵢ and σⱼ are input variables. σᵢ and σⱼ each indicate one of binary values of +1 and −1. σᵢ and σⱼ correspond to states of the spin s in FIG. 1. Jᵢⱼ is an interaction parameter. Jᵢⱼ corresponds to the forcing force F in FIG. 1. hᵢ is a parameter associated with external factors.

Quadratic unconstrained binary optimization (QUBO) is a calculation model that can be equivalently converted into an Ising model. In the Ising model, each bit b is represented by binary variables of +1 and −1, whereas each bit b is represented by binary variables of 0 and 1 in QUBO. QUBO can be applied to a calculation model as well as an Ising model. QUBO is represented by the following energy function (cost function).

$$H = {\sum }_{i , j} {Q}_{ij} {q}_{i} {q}_{j} \qquad [ Equation 2 ]$$

Here, qᵢ and qⱼ are input variables. qᵢ and qⱼ indicate one of binary values of 1 and 0. qᵢ and qⱼ correspond to the states of the spin s in the Ising model. Qᵢⱼ is an interaction parameter in QUBO. Qᵢⱼ corresponds to the forcing force F in the Ising model. Ising energy is an output when values of the input variables qᵢ and qⱼ are input to an energy function.

The Ising model and QUBO can be applied to combinatorial optimization problems. For example, when the QUBO is applied to a combinatorial optimization problem, the combinatorial optimization problem is first converted to Qᵢⱼ to be expressed as an energy function, and each option in the combinatorial optimization problem is expressed as a combination of binary variables of input variables qᵢ and qⱼ. Next, the combinatorial optimization problem can be solved by obtaining a combination of the values of qᵢ and qⱼ that makes Ising energy smaller.

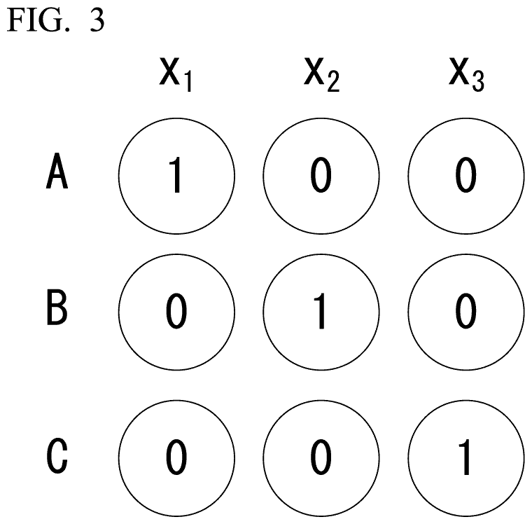

The calculation model according to the present embodiment has a plurality of Ising bits and auxiliary bits. FIG. 2 is an image diagram of an example of the calculation model according to the present embodiment.

Ising bits x₁ to x₃ and an auxiliary bit y₁ each are binary variables. The number of Ising bits x₁ to x₃ is not limited to three. The number of auxiliary bits y₁ is also not limited to one.

The Ising bits x₁ to x₃ and the auxiliary bit y₁ each indicate, for example, 1 or 0. The Ising bits x₁ to x₃ and the auxiliary bit y₁ may each indicate, for example, +1 or −1. The Ising bits x₁ to x₃ and the auxiliary bit y₁ each correspond to the bit b in FIG. 1.

The Ising bits x₁ to x₃ represent each option in the combinatorial optimization problem using a combination of binary variables. For example, in a case of a traveling salesman problem. there are options for which cities to visit and in what order. For example, an option to go to a city M in an N^{th} order becomes an option A.

Options of the Ising bits x₁ to x₃ may be one-hot represented or binary represented.

FIG. 3 is an example of displaying options in one-hot representation. One-hot representation is a method of expressing N types of information using N bits. In the case of one-hot representation, only one of the N bits becomes “1” and all other bits become “0.” In FIG. 3, the option A is assigned to (1,0,0), an option B is assigned to (0,1,0), and an option C is assigned to (0,0,1).

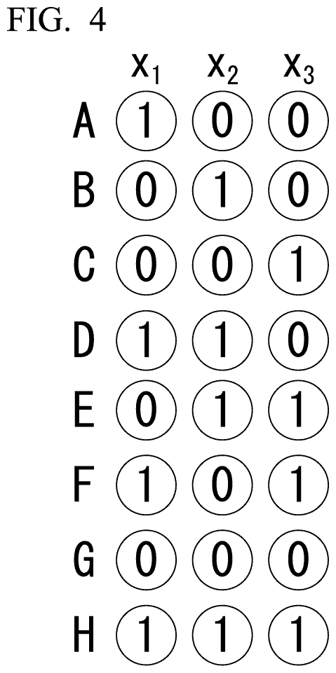

FIG. 4 is an example of a case in which options are displayed in binary representation. Binary representation is a method of expressing N types of information in binary numbers. In the case of binary representation, a plurality of bits are allowed to be “1” at the same time. In FIG. 4, the option A is assigned to (1,0,0), an option B is assigned to (0,1,0), an option C is assigned to (0,0.1), an option D is assigned to (1,1.0), an option E is assigned to (0,1,1), an option F is assigned to (1,0,1), an option G is assigned to (0,0,0), and an option H is assigned to (1,1,1).

Binary representation has an advantage of being able to express a plurality of states with a small number of bits. On the other hand, in a binary representation, if one of the bits is rewritten with noise or the like, it will represent a different state. For this reason, in binary representation, measures against noise is required.

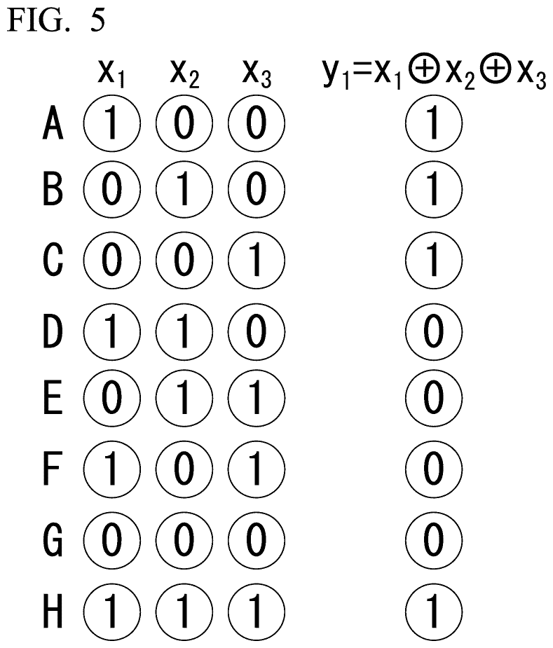

FIG. 5 is an image diagram of an example of assignment of options of an optimization problem to a calculation model according to the present embodiment. The auxiliary bit y₁ indicates a value obtained by logical calculation of two or more values among a plurality of values indicating an option. Here. “a plurality of values indicating options” means each component that makes up a number assigned to options. For example, when the option A is assigned to (1,0,0), “1,” “0,” and “0” each correspond to “a plurality of values indicating options.”

The auxiliary bit y₁ shown in FIG. 5 is a value obtained by performing exclusive OR on all the values among the plurality of values indicating options. Logical calculation may be exclusive OR, logical disjunction, or logical conjunction.

The calculation model according to the present embodiment is not likely to be affected by an error in which bit reversal occurs in any of Ising bits x₁ to x₃ even if the error has occurred.

Errors occur when unintended quantum transitions, noise, and the like occur in quantum annealing machines. For example, when quantum annealing machines normally output the option A (x₁,x₂,x₃)=(1,0,0) in FIG. 5 as an option with smaller Ising energy, it is assumed that the Ising bit x₁ is not “1” but inverted to “0” due to occurrence of noise. In this case, the quantum annealing machines erroneously output the option G (x₁,x₂,x₃)=(0,0,0) due to the noise.

The calculation model of the present embodiment detects an error using the auxiliary bit y₁. The information processing method using the calculation model according to the present embodiment will be described below.

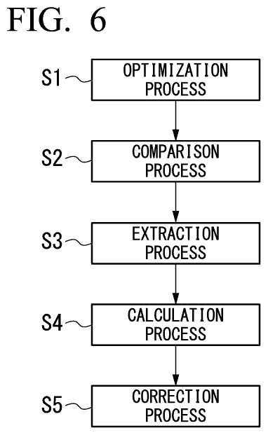

FIG. 6 is a process flow of a information processing method according to the present embodiment. The information processing method according to the present embodiment includes, for example, an optimization process S1, a comparison process S2, an extraction process S3, a calculation process S4, and a correction process S5.

In the optimization process S1, calculation is performed to solve the optimization problem using the calculation model described above. For example, in a case of a QUBO, first, the options of the optimization problem are applied to the energy function described above (cost function). For example, the Ising bits x₁ to x₃ and the auxiliary bit y₁ are applied to input variables qᵢ and qⱼ of the energy function described above. Next, the calculation model outputs values of the input variables qᵢ and qⱼ that make Ising energy smaller on the basis of the energy function. Then, values of the corresponding Ising bits x₁ to x₃ and auxiliary bit y₁ are obtained from the input variables qᵢ and qⱼ.

The comparison process S2 is performed, for example, every time the optimization process S1 is performed. The comparison process S2 does not necessarily need to be performed every time the optimization process S1 is performed, and may be performed at an appropriately set timing.

In the optimization process S1, the calculation model may output a combination of the plurality of Ising bits x₁ to x₃. In that case, the calculation model executes the comparison process S2 and subsequent steps for the values of each of the Ising bit x₁ to x₃.

In the comparison process S2, the value of the auxiliary bit y₁ output in the optimization process S1 and a result of the same logical calculation as when the value of the auxiliary bit y₁ is obtained for an Ising bit corresponding to a value used for the logical calculation of the auxiliary bit y₁ are compared.

For example, in a case shown in FIG. 5, the auxiliary bit y₁ is obtained according to the exclusive OR of three values representing options in the optimization problem. The three values representing options in the optimization problem correspond to each of the Ising bits x₁ to x₃.

For example, calculation of the exclusive OR is performed for the Ising bits x₁ to x₃. The exclusive OR is the same logical calculation as when the value of the auxiliary bit y₁ is obtained. If no error occurs, the same logical calculation is performed, so that a result of the calculation and the value of auxiliary bit y₁ match. For example, in the option A of FIG. 5, the exclusive OR is “1” for the Ising bits x₁ to x₃, which matches the value of the auxiliary bit y₁.

On the other hand, if an error occurs in 1 bit of the Ising bits x₁ to x₃, the values of the Ising bits x₁ to x₃ will be different values. For example, it is assumed that the Ising bit x₁ in the option A in FIG. 5 is erroneously recognized as “0” instead of “1” due to an error. In this case, in a case of the option A, the exclusive OR for the Ising bits x₁ to x₃ is “0.” The result of the calculation and the value of the auxiliary bit y₁ do not match.

In other words, when the result of the calculation and the value of the auxiliary bit y₁ do not match, it can be said that an error has occurred.

The information processing method according to the present embodiment can detect an error by repeating the optimization process S1 and the comparison process S2.

Next, the extraction process S3, the calculation process S4, and the correction process S5 will be performed. These steps are performed when an error is detected.

In the extraction process S3, combinations of variables that can be selected by the Ising bits x₁ to x₃ are listed based on the value of the auxiliary bit y₁.

For example, in the option A of FIG. 5, a case will be described as an example in which results of the logical calculations for the Ising bits x₁ to x₃ do not match the value of the auxiliary bit y₁. When the value of the auxiliary bit y₁ is “1,” as the combinations of variables that can be selected by the Ising bits x₁ to x₃, (x₁,x₂,x₃)=(1,0,0), (0,1,0). (0,0,1) and (1,1,1) are considered. In the extraction process S3, all possible combinations of these variables are listed.

Next, in the calculation process S4, calculation is performed using the calculation model described above for each combination of all variables extracted in the extraction process S3. For example, each of (x₁,x₂,x₃)=(1,0,0), (0,1,0), (0,0,1), (1,1,1) listed in the extraction process S3 is applied to the calculation model to perform calculation. When the calculation is performed, an Ising energy for each combination of variables is obtained.

When the calculation process S4 is intended to be performed in a short time, the combinations of variables that can be selected by the Ising bits x₁ to x₃ may be appropriately reduced in the extraction process S3. For example, when (x₁,x₂,x₃)=(0,0,0) and the value of the auxiliary bit y₁ is “1” as a result of the optimization process S1, (x₁,x₂,x₃)=(1,0,0), (0,1,0), and (0,0,1) may also be extracted as the combinations of variables that can be selected by the Ising bits x₁ to x₃ in which the value of the auxiliary bit y₁ satisfies “1,” and the Hamming distance with (x₁,x₂,x₃)=(0,0.0) is 1. Hamming distance is the number of different characters in corresponding positions in two strings with the same number of characters. In other words, the Hamming distance is a measurement of the number of substitutions required to transform one character string into another.

Next, the correction process S5 is performed based on a result of the calculation process S4. In the correction process S5, the values of the Ising bits x₁ to x₃ are corrected using the combination of variables that minimizes the Ising energy in the calculation process S4. For example, it is assumed that results of the calculated Ising energy for each of (x₁,x₂,x₃)=(1,0,0), (0,1,0), (0,0,1), (1,1.1) are H1, H2, H3, H4, and H5, and a magnitude of the Ising energy is H1<H2<H3<H4<H5. In this case, the values of the Ising bits x₁ to x₃ when an error is detected are replaced with a combination (x₁,x₂,x₃)=(1,0,0) where the magnitude of the Ising energy is the smallest.

When the correction process S5 is performed, the values of the Ising bits x₁ to x₃ are corrected. Therefore, the information processing method according to the present embodiment can perform error correction by performing the extraction process S3, the calculation process S4, and the correction process S5.

The optimization process S1 is executed by, for example, an Ising machine specialized for calculating an Ising model and a QUBO. For example, machines such as quantum annealing machines (D-wave, NEC), coherent Ising machines (NTT), simulated branching machines (Toshiba), digital annealers (Fujitsu), and CMOS annealers (Hitachi) are examples of Ising machines.

The Ising machine may be a quantum gate type computer. For example, if a quantum approximate optimization algorithm (QAOA) is used, an Ising model and a QUBO can be calculated with a quantum gate type computer.

The comparison process S2, the extraction process S3, the calculation process S4, and the correction process S5 are executed using a general-purpose information processing device with versatility. For example, machines such as personal computers, super computers, and micro computers are examples of general-purpose information processing devices. Between the optimization process S1 and the comparison process S2, the Ising machine transmits the values of an Ising bit and an auxiliary bit obtained in the optimization process S1 to the general-purpose information processing device, and the general-purpose information processing device executes the comparison process S2 and subsequent steps using the values of the Ising bit and the auxiliary bit transmitted from the Ising machine.

Additionally, the optimization process S1 may be executed by the general-purpose information processing device described above.

The Ising machine and the general-purpose information processing device perform the information processing described above on the basis of a calculation program including an optimization program, a comparison program, an extraction program, a calculation program, and a correction program.

The optimization program performs the optimization process S1. The comparison program performs the comparison process S2. The extraction program performs the extraction process S3. The calculation program performs the calculation process S4. The correction program performs the correction process S5.

According to the calculation program and information processing device of the present embodiment, errors can be detected using the auxiliary bit y₁, and an appropriate optimal solution can be obtained.

The embodiments of the present invention have been described above in detail with reference to the drawings, but each configuration and combination thereof in each embodiment is merely an example, and additions, omissions, replacement, and other changes of configurations may be made within a range not departing from the gist of the present invention.

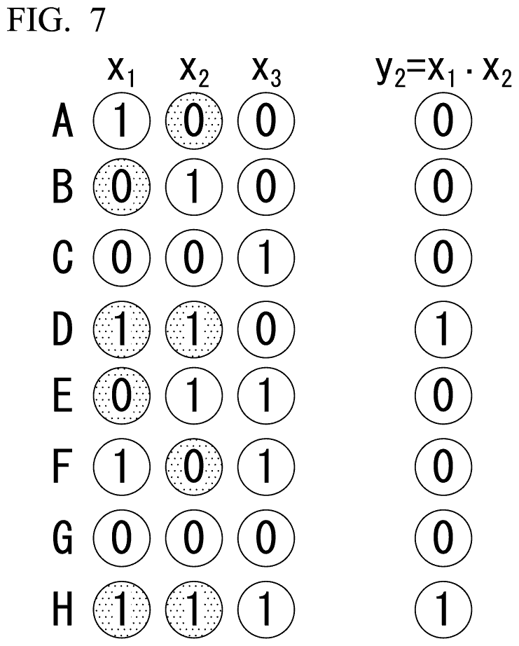

For example, when an auxiliary bit is obtained, it is not necessary to use all of a plurality of values indicating options. For example, in FIG. 7, a value that is a logical conjunction of two values among the plurality of values indicating options as an auxiliary bit y₂.

In the case shown in FIG. 7, when an error occurs in the Ising bits x₁ to x₃ whose insides are indicated by dots, a value of the auxiliary bit y₂ and the value of the logical conjunction of the Ising bits x₁ and x₂ do not match. That is, in the case shown in FIG. 7, errors occurring in at least some of the Ising bits x₁ to x₃ can be detected.

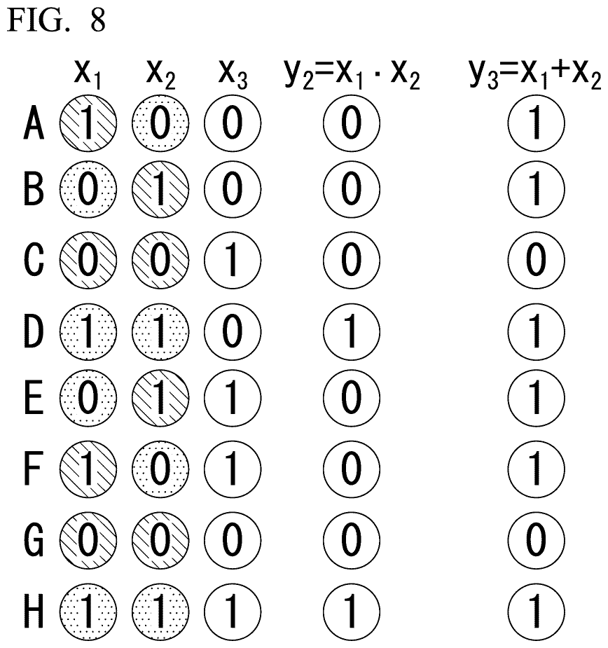

In addition, for example, the number of auxiliary bits is not limited to one, but may be plural. FIG. 8 is an example in which there are a plurality of auxiliary bits. In FIG. 8, the auxiliary bit y₂ is a value that is a logical conjunction of two values among the plurality of values indicating options, and an auxiliary bit y₃ is a value that is a logical disjunction of two values among the plurality of values indicating options.

In the case shown in FIG. 8, when an error occurs in the Ising bits x₁ to x₃ whose insides are indicated by dots, the value of the auxiliary bit y₂ and the value of the logical conjunction of the Ising bits x₁ and x₂ do not match. Moreover, when an error occurs in the Ising bits x₁ to x₃ whose insides are indicated by diagonal lines, the value of the auxiliary bit y₃ and the value of the logical disjunction of the Ising bits x₁ and x₂ do not match. That is, in the case shown in FIG. 8, errors occurring in at least some of the Ising bits x₁ to x₃ can be detected. A part where errors can be detected using the auxiliary bit y₂ and a part where errors can be detected using the auxiliary bit y₃ are different from each other, and errors can be detected in a wider range.

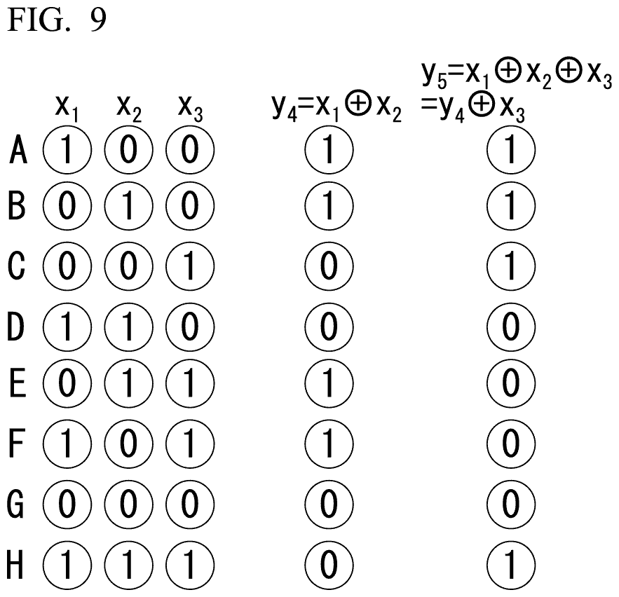

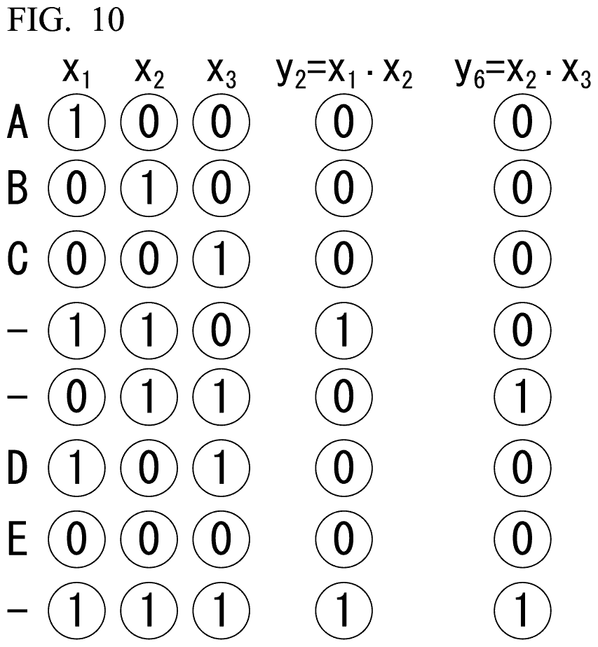

Further, for example, as shown in FIG. 9, the number of values used for logical calculation of the auxiliary bits may be different for each auxiliary bit. For example, in FIG. 9, an auxiliary bit y₄ is an exclusive OR of two values among the plurality of values indicating options, and an auxiliary bit y₅ is an exclusive OR of three values among the plurality of values indicating options. An auxiliary bit y₅ is also an exclusive OR of the auxiliary bit y₄ and a value (x₃) that is not used in a logical calculation of the auxiliary bit y₄ among the plurality of values indicating options.

An Ising model and a QUBO can calculate two-body problems using two variables, but cannot calculate multi-body problems using two or more variables. As shown in FIG. 9, by using the auxiliary bit y₄, a three-body problem of the Ising bits x₁. x₂, and x₃ can be replaced with a two-body problem of the auxiliary bit y₄ and an Ising bit x₃.

The auxiliary bit can also be used to set constraints for the Ising model and the QUBO.

As shown in FIG. 10, there are cases where the number of options in the optimization problem is smaller than the number of combinations of binary representations of the Ising bits x₁ to x₃. FIG. 10 shows an example where the number of combinations of the Ising bits x₁ to x₃ is eight, and there are five options, A, B, C, F, and G.

In FIG. 10, when numerical values are assigned to options A, B, C, D, and E, the assignment is performed according to a fixed rule. The fixed rule here is a rule that options are not assigned to combinations in which at least one of the auxiliary bit y₂ and the auxiliary bit y₆ is “1.”

By performing such assignment and giving constraints on combinations in which at least one of the auxiliary bit y₂ and the auxiliary bit y₆ is “1,” a speed of information processing can be increased.

Constraints are given to the energy function. For example, if interaction parameters are defined so that the Ising energy becomes large in calculation for solving an optimization problem using the auxiliary bit y₂ and the auxiliary bit y₆, constraints can be given to the energy function. More specifically, k₁y₂+k₂y₆ is given to the energy function. k₁ and k₂ are coefficients of the constraint terms and have values greater than 0.

Computers calculate combinations that humans would exclude as equivalent to other combinations. By adding the constraints described above, it is possible to exclude impossible combinations for which options have not been assigned from the calculation; for solving the optimization problem. The speed of information processing increases 5 when unnecessary combinations are eliminated.

An auxiliary bit y₂ and an auxiliary bit y6 provide constraints and can also be used to detect errors in the Ising bits x₁ to x₃.

### DESCRIPTION OF SYMBOLS

Bit
x₁ to x, Ising bit
y₁ to y₆ Auxiliary bit

1. A calculation model that is applicable to an Ising model or a QUBO, comprising:
a plurality of Ising bits and a first auxiliary bit,
wherein each of the plurality of Ising bits and the first auxiliary bit is a binary variable,
the plurality of Ising bits represent each of the options in combinatorial optimization problems as a combination of the variables, and
the first auxiliary bit indicates a value obtained by performing logical calculation on two or more values among a plurality of values indicating the options.

2. The calculation model according to claim 1, wherein the logical calculation is an exclusive OR.

3. The calculation model according to claim 1, wherein the logical calculation is a logical disjunction.

4. The calculation model according to claim 1, wherein the logical calculation is a logical conjunction.

5. The calculation model according to claim 4, further comprising:
a second auxiliary bit,
wherein the second auxiliary bit indicates a value obtained by performing a logical disjunction of two or more values among a plurality of values indicating the options.

6. The calculation model according to claim 1, wherein the plurality of Ising bits perform binary representation on the options.

7. The calculation model according to claim 1, further comprising:
a third auxiliary bit,
wherein the third auxiliary bit indicates a value obtained by performing a logical calculation on a value of the first auxiliary bit and a value that is not used in the logical calculation to obtain the first auxiliary bit among a plurality of values indicating the options.

8. The calculation model according to claim 1, wherein the Ising model or the QUBO is executed by quantum annealing machines.

9. An information processing method using the calculation model according to claim 1, comprising:
a comparison process of comparing a value of the first auxiliary bit with a result of performing the same logical calculation as when a value of the first auxiliary bit is obtained for an Ising bit corresponding to a value used in the logical calculation of the first auxiliary bit.

10. The information processing method according to claim 9, further comprising:
an extraction process of enumerating combinations of the variables that are selectable by the plurality of Ising bits from the value of the first auxiliary bit when comparison results in the comparison process do not match;
a calculation process of performing a calculation using the calculation model for each of the listed combinations; and
a replacement process of replacing a combination of variables of the plurality of Ising bits when an error is detected with a combination of variables that minimizes a result of calculation among the combinations of the variables that are selectable by the plurality of Ising bits.

11. The information processing method according to claim 10, wherein a combination having a small Hamming distance with the plurality of Ising bits is extracted from among the combinations of the variables that are selectable by the plurality of Ising bits in the extraction process.

12. A storage medium that stores a calculation program, the calculation program comprising:
a calculation program that performs a calculation using the calculation model according to claim 1; and
a comparison program that compares the value of the first auxiliary bit with a result of performing the same logical calculation as when a value of the first auxiliary bit is obtained for an Ising bit corresponding to the value used in the logical calculation of the first auxiliary bit.

13. The storage medium according to claim 12, the calculation program further comprising:
an extraction program that lists combinations of the variables that are selectable by the mismatched options on the basis of the value of the first auxiliary bit when the comparison results using the comparison program do not match; and
a correction program that replaces variables when the comparison results do not match with the combination of variables that minimizes a result of calculation using the calculation program among the combinations of the variables that are selectable by the options.

14. An information processing device comprising the calculation program according to claim 12.
